(19) United States
(12) Patent Application Publication
(10) Pub. No.: US 2026/0268040 A1
(43) Pub. Date: Sep. 10, 2026

(54) ENTROPY RESPECTING APPROXIMATION OF LAGRANGIAN PARTICLE TRACKING

(71) Applicant: Actea, Inc., San Francisco, CA (US)

(72) Inventors: Trond Kristiansen, San Francisco, CA (US); Jordan Hood Miller, San Francisco, CA (US)

(21) Appl. No.: 19/561,385

(22) Filed: Mar. 9, 2026

Related U.S. Application Data
(60) Provisional application No. 63/768,756, filed on Mar. 7, 2025.

(51) Int. Cl. G06F 30/25; G06F 30/28

(52) U.S. Cl. CPC G06F 30/25; G06F 30/28

(57) ABSTRACT

The disclosed embodiments provide a technique for modeling particle movement within a fluid domain. The technique includes dividing the fluid domain that includes a plume into a plurality of cells. The technique also includes relocating a subset of the plurality of particles in the cell to one or more additional cells in the plurality of cells and determining a plurality of trajectories for the plurality of particles based on the relocated subset of the plurality of particles upon determining, during a current time step of a plume dispersal simulation, that a particle limit associated with a cell is exceeded by a count of a plurality of particles that (i) represent at least a subset of the plume and (ii) are located in the cell. The technique further includes causing a set of predicted effects associated with the plume to be generated based on the plurality of trajectories.

### RELATED APPLICATION

This application claims the benefit of U.S. Provisional Application No. 63/768,756, Attorney Docket Number ACTE.0003L, entitled “Entropy Respecting Approximation of Lagrangian Particle Tracking,” by inventors Trond Kristiansen and Jordan H. Miller, filed Mar. 7, 2025, which is incorporated herein by reference in its entirety.

### BACKGROUND

### Field

The disclosed embodiments relate to climate modeling. More specifically, the disclosed embodiments relate to techniques for performing entropy respecting approximation of Lagrangian particle tracking.

### Related Art

Marine carbon dioxide removal (mCDR) refers to various technologies for capturing and storing carbon dioxide from the ocean. For example, mCDR techniques may involve electrochemically removing dissolved carbon dioxide from water, adding alkaline substances to seawater, downward transfer of surface water and carbon to the deep ocean, storing carbon dioxide (CO₂) in underground geological formations, use of macroalgae to convert dissolve CO₂ into organic carbon through photosynthesis, and/or coastal enhanced weathering that places carbon-removing sand into seawater. An mCDR invention typically aims to lower the partial pressure of carbon dioxide (pCO₂) in seawater, thereby increasing the flux and/or absorption of CO₂ from the air to the ocean.

However, it can be difficult to measure and/or quantify the effects of a given mCDR intervention and/or set of mCDR interventions. These effects can include the increase in carbon dioxide flux, referred to as Removal Potential Attained (RPA), attained by a given mCDR intervention and/or set of mCDR interventions. These effects can also, or instead, include the impact of the mCDR intervention(s) on the environment. This uncertainty in RPA and/or environmental impact is generally due to the extended time scale (e.g., several months to years) over which the marginal flux increases. Over this period, the affected water with decreased pCO₂ can sink and leave contact with the atmosphere, and the biogeochemistry of the ocean can vary due to a wide range of complex factors. Additionally, interactions between mCDR technologies and the climate can affect the movement of water in the ocean and/or the biogeochemistry of the ocean over time. Thus, ocean modeling is typically used to perform measurement, reporting, and verification (MRV) of the RPA and/or environmental impact of an mCDR intervention based on these complex factors and lengthy time scales.

Conventional techniques for modeling the effects of mCDR interventions involve the use of dynamic hydrodynamic models such as the regional ocean modeling systems (ROMS) to compute voxel-level interactions resulting from an mCDR intervention. However, these ROMS-based techniques are difficult and time-consuming to configure and use computationally complex dynamic models and Eulerian diffusion tracking approaches to deterministically compute concentrations of particles over space and time. The significant resource overhead associated with these techniques further precludes in-depth MRV analysis across combinations of multiple sites, mCDR interventions, climate scenarios, and/or other factors and can contribute to delays in the adoption and/or use of mCDR interventions.

Consequently, more effective techniques for modeling mCDR systems are needed.

### BRIEF DESCRIPTION OF THE FIGURES

FIG. 1 illustrates a computer system in accordance with the disclosed embodiments.

FIG. 2 illustrates a system for performing stochastic modeling of marine carbon dioxide removal (mCDR) in accordance with the disclosed embodiments.

FIG. 3 illustrates the use of a plume dispersal simulation to compute intervention concentrations associated with one or more mCDR interventions, in accordance with the disclosed embodiments.

FIG. 4 illustrates a set of carbonate system calculations in accordance with the disclosed embodiments.

FIG. 5 illustrates a set of air-sea flux calculations in accordance with the disclosed embodiments.

FIG. 6 illustrates the generation of a set of results associated with stochastic modeling of one or more mCDR interventions, in accordance with the disclosed embodiments.

FIG. 7 illustrates a flowchart of method steps for modeling an mCDR system in accordance with the disclosed embodiments.

FIG. 8 illustrates a particle tracking model that corrects for inconsistencies in the distribution of particles generated via a Lagrangian particle tracking technique, in accordance with the disclosed embodiments.

FIG. 9 illustrates a flowchart of method steps for modeling particle movement within a fluid domain, in accordance with the disclosed embodiments.

In the figures, like reference numerals refer to the same figure elements.

### DETAILED DESCRIPTION

The following description is presented to enable any person skilled in the art to make and use the embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present disclosure. Thus, the present invention is not limited to the embodiments shown, but is to be accorded the widest scope consistent with the principles and features disclosed herein.

### Overview

As discussed above, it can be difficult to measure and/or quantify the effects of a given marine carbon dioxide removal (mCDR) intervention and/or set of mCDR interventions. Further, conventional techniques for modeling the effects of mCDR interventions involve the use of dynamic hydrodynamic models, such as the regional ocean modeling systems (ROMS), to compute voxel-level interactions resulting from an mCDR intervention. However, these techniques are difficult and time-consuming to configure and use computationally complex dynamic models and Eulerian diffusion tracking approaches to deterministically compute concentrations of particles over space and time. The significant resource overhead associated with these techniques further precludes in-depth measurement, reporting, and verification (MRV) analysis across combinations of multiple sites, mCDR interventions, climate scenarios, and/or other factors and can interfere with adoption and/or use of mCDR interventions.

To address the above limitations, the disclosed embodiments provide a technique for performing stochastic modeling of one or more mCDR interventions. This stochastic modeling technique uses a Lagrangian particle tracking technique to simulate the dispersal of particles associated with the mCDR intervention(s). For example, the Lagrangian particle tracking technique may be used to convert release times, release locations, masses of interventions, and/or other attributes of one or more plume source definitions associated with the mCDR intervention(s) into one or more corresponding sets of particles. The Lagrangian particle tracking technique may then be used to compute trajectories for these particles over a prespecified time period and/or geographic range based on a set of ocean conditions, which can be determined by performing statistical downscaling of climate projections and/or other types of observations. Noise may be injected into the set of ocean condition inputs with a magnitude based on the corresponding uncertainties, and wind-driven turbulent mixing may be represented in the tracking to further add non-deterministic behavior to the stochastic model. The trajectories are then used to determine intervention concentrations associated with the particles over space and time.

Next, the stochastic modeling technique uses the intervention concentrations to iteratively compute changes to the state of a carbonate system and an air-sea flux over time. At a given time step, a set of baseline carbonate system values that would be produced in the absence of the mCDR intervention(s) is computed. The baseline carbonate system values and the intervention concentrations are used to compute a set of intervention carbonate system values that would be produced in the presence of the mCDR intervention(s). The baseline carbonate system values are then used to compute a baseline air-sea flux that would occur in the absence of the mCDR intervention(s), and the set of intervention carbonate system values are used to compute an intervention air-sea flux that would occur in the presence of the mCDR intervention(s). A change in air-sea flux is additionally computed as the difference between the baseline flux and the intervention flux. The output of a time step is further used to calculate new baseline and/or intervention carbonate system values and air-sea fluxes for the next time step.

The baseline and intervention values for carbonate system states and/or air-sea fluxes are aggregated over time and/or spatial domains to estimate the effects of the mCDR intervention(s). For example, baseline and/or intervention values in air-sea fluxes that span a certain number of years and/or a certain geographic region may be summed to estimate carbon sequestration associated with the mCDR intervention(s). In another example, baseline and/or intervention values for pH within the carbonate system may be averaged over a certain time period and/or geographic region to determine a mitigation in ocean acidification associated with the mCDR intervention(s).

Because stochastic techniques are used to model dispersal dynamics associated with mCDR interventions, the disclosed embodiments are faster and more resource-efficient than conventional methods that involve resource-intensive configuration of ROMS that are used to compute voxel-level interactions resulting from an mCDR intervention and/or dynamic downscaling and Eulerian diffusion tracking to deterministically compute concentrations of particles over space and time. This increase in speed and efficiency additionally allows mCDR modeling to be performed across different combinations of sites, mCDR interventions, climate scenarios, and/or other factors. Consequently, the disclosed embodiments improve the understanding of uncertainties and/or variations in the Removal Potential Attained (RPA) and/or environmental impact of one or more mCDR interventions and the identification, adoption, and/or use of safe and effective mCDR interventions.

### Stochastic Modeling of Marine Carbon Dioxide Removal

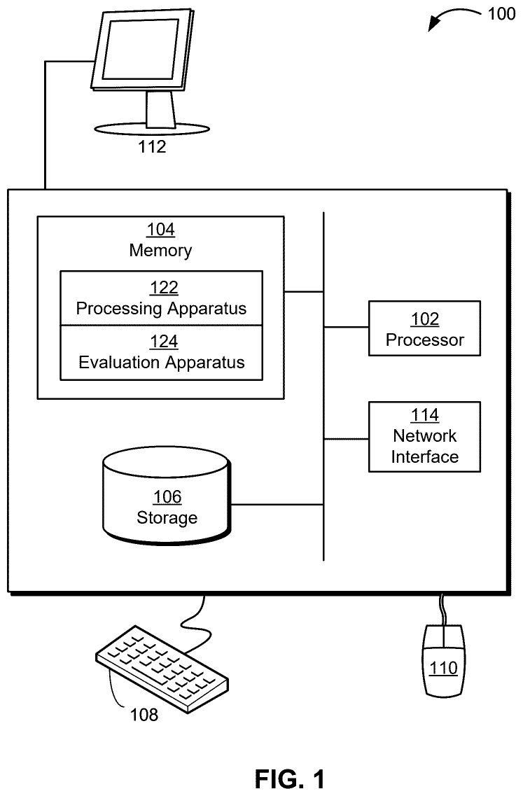

FIG. 1 shows a computer system 100 within which the disclosed embodiments can be implemented. Computer system 100 includes a processor 102, a memory 104, a storage 106, a network interface 114, and/or other components found in electronic computing devices. For example, computer system 100 may include (but is not limited to) a desktop computer, a laptop computer, a mobile phone, a personal digital assistant (PDA), a tablet computer, a game console, a smart home device, a server, a workstation, a virtual machine, and/or another arrangement of hardware and/or software components that can be configured to implement one or more disclosed embodiments.

Processor 102 may support parallel processing and/or multi-threaded operation within computer system 100. For example, processor 102 includes (but is not limited to), a central processing unit (CPU), graphics-processing unit (GPU), field programmable gate array (FPGA), application-specific integrated circuit (ASIC), artificial intelligence (AI) accelerator, another type of processing unit, and/or a combination of different processing units (e.g., a CPU operating in conjunction with a GPU).

Memory 104 includes cache memory, dynamic random-access memory (“DRAM”), video random-access memory (“VRAM”), non-volatile memory (e.g., flash memory), and/or other components that can store data. As shown in FIG. 1, memory 104 includes a processing apparatus 122 and an evaluation apparatus 124.

Storage 106 includes non-volatile storage for applications and data. For example, storage 106 may include one or more fixed and/or removable hard disk drives, solid state drives, flash memory devices, CD-ROMs (compact disc read-only-memories), DVD-ROMs (digital versatile disc-ROMs), and/or other magnetic, optical, or solid-state storage devices. Processing apparatus 122 and evaluation apparatus 124 can be stored in storage 106 and loaded into memory 104 when executed. The operation of processing apparatus 122 and evaluation apparatus 124 is described in further detail below.

Computer system 100 also includes input/output (I/O) devices such as (but not limited to) a keyboard 108, a mouse 110, and a display 112. Each I/O device can be capable of receiving input from a user and/or generating output to the user.

Network interface 114 includes hardware and/or software components that connect computer system 100 to a public and/or private network. For example, network interface 114 may include a network interface card (NIC), a virtual network interface (VNI), and/or another representation of an interface between computer system 100 and a network (not shown). The network may include (but is not limited to) a local area network (LAN), wide area network (WAN), personal area network (PAN), virtual private network, intranet, cellular network, Wi-Fi network (Wi-Fi® is a registered trademark of Wi-Fi Alliance), Bluetooth (Bluetooth® is a registered trademark of Bluetooth SIG, Inc.) network, universal serial bus (USB) network, Ethernet network, and/or switch fabric.

Computer system 100 includes functionality to execute various components of the present embodiments. In particular, computer system 100 includes an operating system (not shown) that coordinates the use of hardware and software resources on computer system 100, as well as one or more applications that perform specialized tasks for the user. To perform tasks for the user, applications obtain the use of hardware resources on computer system 100 from the operating system and interact with the user through a hardware and/or software framework provided by the operating system.

In addition, one or more components of computer system 100 may be remotely located and connected to the other components over a network. Portions of the present embodiments (e.g., processing apparatus 122, evaluation apparatus 124, etc.) may also be located on different nodes of a distributed system that implements the embodiments. For example, the present embodiments may be implemented using a distributed and/or cloud computing system that coordinates and/or manages the execution of remote tasks performed by processing apparatus 122 and/or evaluation apparatus 124. In another example, one or more instances of processing apparatus 122 and/or evaluation apparatus 124 may execute on various sets of hardware, types of devices, and/or environments to adapt processing apparatus 122 and/or evaluation apparatus 124 to different use cases or applications. In a third example, processing apparatus 122 and evaluation apparatus 124 may execute on different computer systems and/or different sets of computer systems.

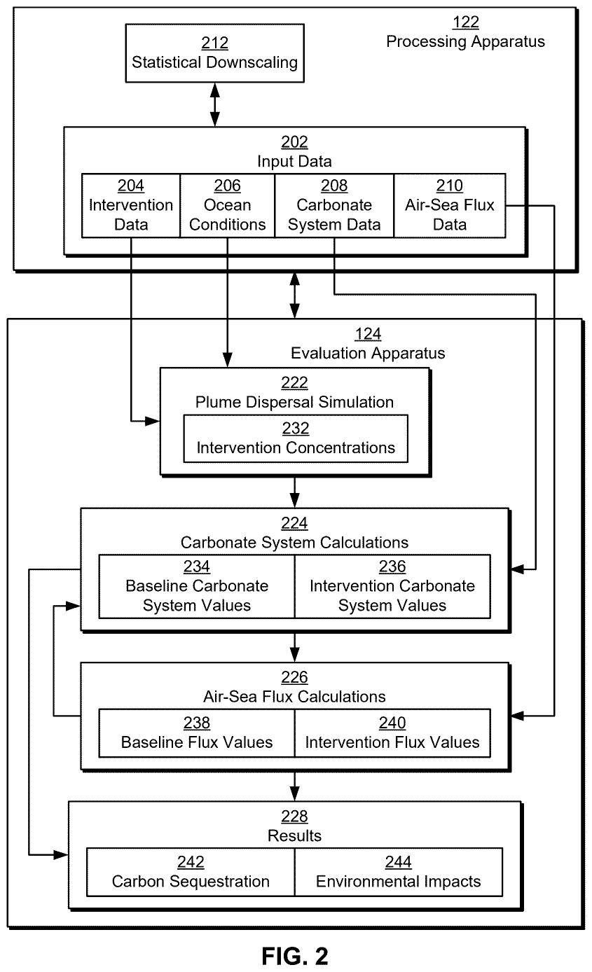

FIG. 2 illustrates a system for performing stochastic modeling of marine carbon dioxide removal (mCDR) in accordance with the disclosed embodiments. As shown in FIG. 2, the system includes processing apparatus 122 and evaluation apparatus 124. Each of these components is described in further detail below.

Processing apparatus 122 collects and/or processes various types of input data 202 associated with an mCDR system that includes one or more mCDR interventions. This input data 202 includes a set of intervention data 204, a set of ocean conditions 206, a set of carbonate system data 208, and a set of air-sea flux data 210.

Intervention data 204 includes attributes associated with the mCDR intervention(s). For example, intervention data 204 for a given mCDR intervention may include a type of intervention (e.g., electrochemical removal of dissolved CO₂, addition of alkaline substances to seawater, downward transfer of surface water and carbon, storing CO₂ in underground geological formations, macroalgal growth to convert dissolve CO₂ into organic carbon through photosynthesis, placing carbon-removing sand into seawater, etc.), the location of the intervention (e.g., a location and/or geographic region at which the mCDR intervention is to be performed), one or more quantities associated with the mCDR intervention (e.g., the amount of alkalinity to be added at the location), and/or other values that can be used to define and/or characterize the mCDR intervention.

Ocean conditions 206 include physical attributes of the ocean and/or another body of water affected by the mCDR intervention(s). For example, ocean conditions 206 may include (but are not limited to) a surface wind velocity, surface current velocity, bottom current velocity, n intermediate current velocities at depth, mixed layer depth (e.g., the depth to which homogenization has occurred due to wind-driven mixing), surface salinity, and/or surface temperature. Ocean conditions 206 may be specified over one or more time periods (e.g., a certain number of years before and/or after a given mCDR intervention) and/or one or more spatial domains (e.g., one or more geographic regions) over which the mCDR system is to be modeled.

Carbonate system data 208 includes values related to the state of the marine carbonate system, which includes chemical equilibria that govern the exchange of CO₂ between the ocean and atmosphere and the corresponding pH response. For example, carbonate system data 208 may include (but is not limited to) dissolved inorganic carbon, substance contents of aqueous CO₂ and/or bicarbonate and/or carbonate ions formed by the hydration and dissociation of the aqueous CO₂; total alkalinity; surface pH; and/or the fugacity, partial pressure, and/or dry-air mole fraction of CO₂ in seawater. Carbonate system data 208 may also, or instead, include attributes associated with ocean conditions 206, such as (but not limited to) surface temperature and/or surface salinity.

Air-sea flux data 210 includes values related to the exchange of CO₂ between the ocean and atmosphere. For example, air-sea flux data 210 may include a gas transfer velocity of CO₂, a solubility of CO₂, a partial pressure of carbon dioxide (pCO₂) at the surface of the ocean, surface atmospheric pCO₂, sea ice fraction, and/or other attributes that can be used to compute air-sea carbon dioxide fluxes. Air-sea flux data 210 may also, or instead, include attributes associated with ocean conditions 206 and/or carbonate system data 208, such as (but not limited to) surface wind velocity, surface temperature, and/or surface salinity.

Processing apparatus 122 obtains some or all of intervention data 204, ocean conditions 206, carbonate system data 208, and/or air-sea flux data 210 from one or more climate datasets. For example, processing apparatus 122 may populate intervention data 204, ocean conditions 206, carbonate system data 208, and/or air-sea flux data 210 with data from global climate models (GCMs), ocean and/or atmospheric reanalyses, observational datasets, and/or other sources of climate data.

In some embodiments, processing apparatus 122 performs statistical downscaling 212 of the climate datasets to generate high-resolution projections of intervention data 204, ocean conditions 206, carbonate system data 208, and/or air-sea flux data 210. These projections may include scalars such as (but not limited to) temperature, salinity, sea ice concentration, pCO₂, and/or pH. These projections may also, or instead, include vectors such as (but not limited to) u and v components of vectors representing surface winds, ocean currents, intermediate currents at depth, and/or bottom currents in a projection of the surface of the globe onto a two-dimensional (2D) space.

During statistical downscaling 212 of input data 202, processing apparatus 122 may obtain one or more lower-resolution climate projection datasets and one or more higher-resolution observational datasets. Processing apparatus 122 may upsample and/or downsample the spatial resolution and/or coordinate system associated with each dataset using spherical grid extrapolation and regridding techniques. Processing apparatus 122 may also use a trend-preserving climatology removal process to aggregate relatively sparse (e.g., monthly) data points that span multiple years within the datasets into an anomaly time series that spans a month. During the trend-preserving climatology removal process, trend and climatology components may be removed from a given set of data points to generate a trendless anomaly time series, and the trend component may be added back to the trendless anomaly time series to produce a corresponding trend-preserved anomaly time series.

Processing apparatus 122 may also train a bias correction and/or statistical downscaling technique using the anomaly time series generated from the climate projection dataset(s) and observational dataset(s). During the training process, processing apparatus 122 may learn parameters that model relationships between the climate projection dataset(s) and the observational dataset(s). After the training process is complete, processing apparatus 122 may perform an inference process that uses the parameters to generate an anomaly projection from data points that span a future time period within the climate projection dataset(s). Processing apparatus 122 may then perform a climatology addition process that is a reverse of the trend-preserving climatology removal process to convert the anomaly projection into a climate projection. Statistical downscaling of ocean climate systems is described in a co-pending non-provisional application by the same inventors as the instant application entitled “Bias Correction and Statistical Downscaling of Ocean Climate Systems,” having Ser. No. 18/475,263, Attorney Docket Number ACTE.0001, and filing date Sep. 27, 2023, which is incorporated herein by reference in its entirety.

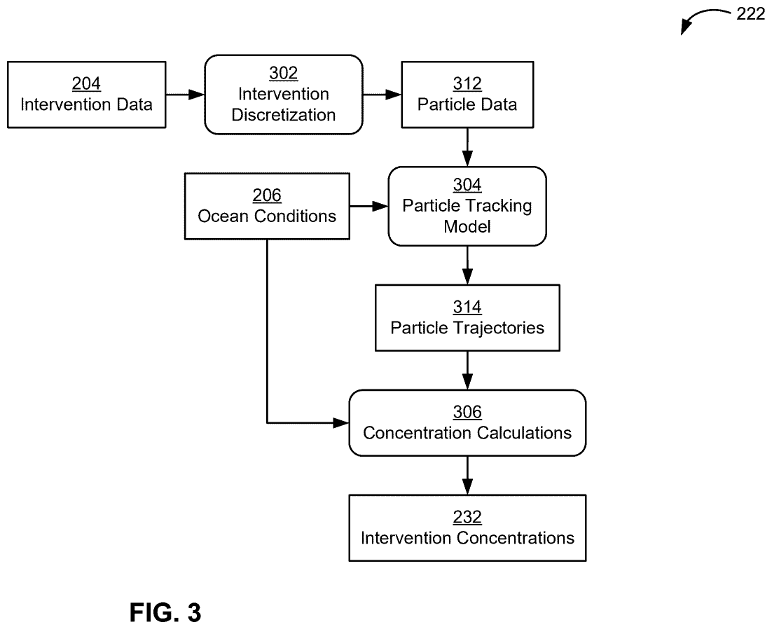

Evaluation apparatus 124 uses input data 202 from processing apparatus 122 to model the effects of the mCDR intervention(s) across one or more spatial domains and/or temporal domains. More specifically, evaluation apparatus 124 performs a plume dispersal simulation 222 that is used to compute intervention concentrations 232 associated with the mCDR intervention(s) from intervention data 204 for the mCDR intervention(s) and ocean conditions 206 associated with the spatial domains and/or temporal domains. Plume dispersal simulation 222 is described in further detail below with respect to FIG. 3.

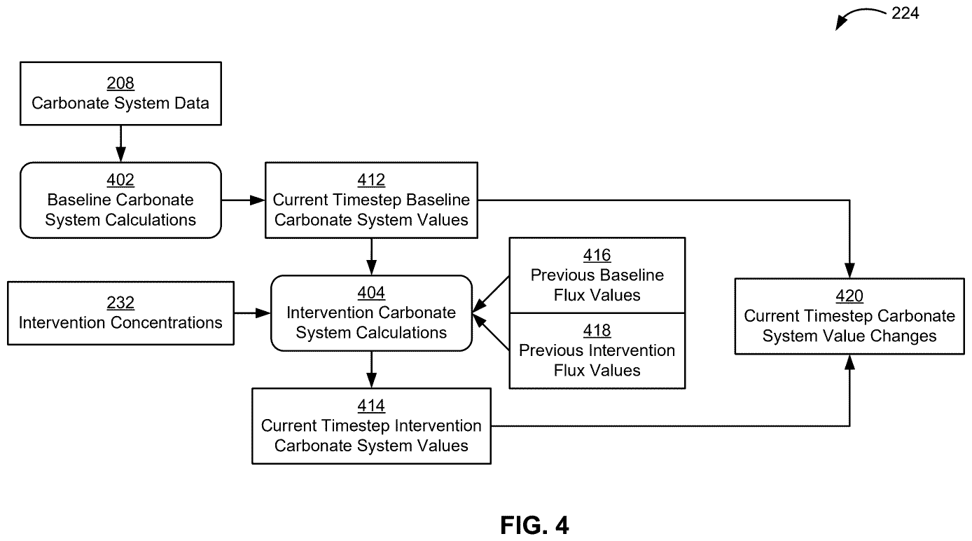

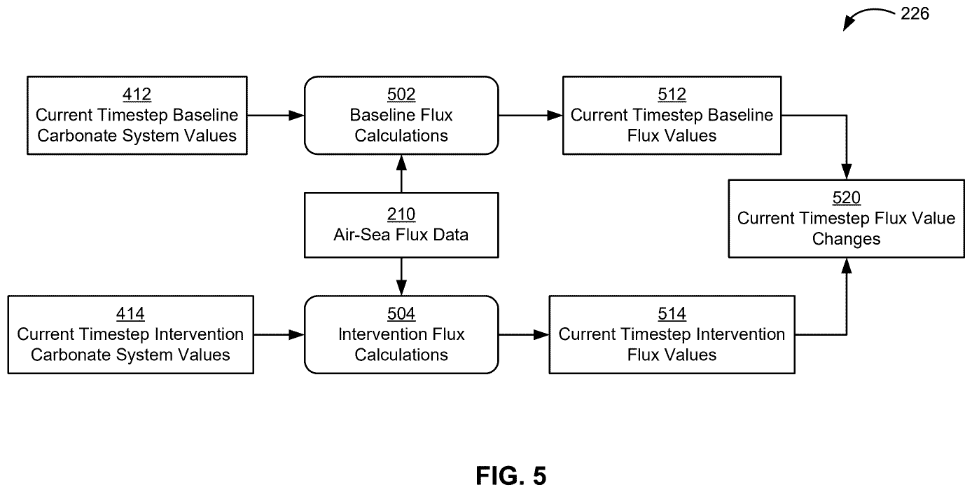

Next, evaluation apparatus 124 uses intervention concentrations 232 to iteratively perform a set of carbonate system calculations 224 and a set of air-sea flux calculations 226 over a series of timesteps that span the time domain over which the effects of the mCDR intervention(s) are to be evaluated. In particular, carbonate system calculations 224 involve computing, for a given timestep from intervention concentrations 232 and carbonate system data 208, a set of baseline carbonate system values 234 for a carbonate system that does not include the mCDR intervention(s) and a set of intervention carbonate system values 236 for a carbonate system that includes the mCDR intervention(s). Baseline carbonate system values 234 and air-sea flux data 210 for a given timestep are used in air-sea flux calculations 226 that produce a set of baseline flux values 238 that would occur in the absence of the mCDR intervention(s) for the same timestep. Similarly, intervention carbonate system values 236 and air-sea flux data 210 for a given timestep are used in air-sea flux calculations 226 that produce a set of intervention flux values 240 that would occur in the presence of the mCDR intervention(s). Carbonate system calculations 224 are described in further detail below with respect to FIG. 4, and air-sea flux calculations 226 are described in further detail below with respect to FIG. 5.

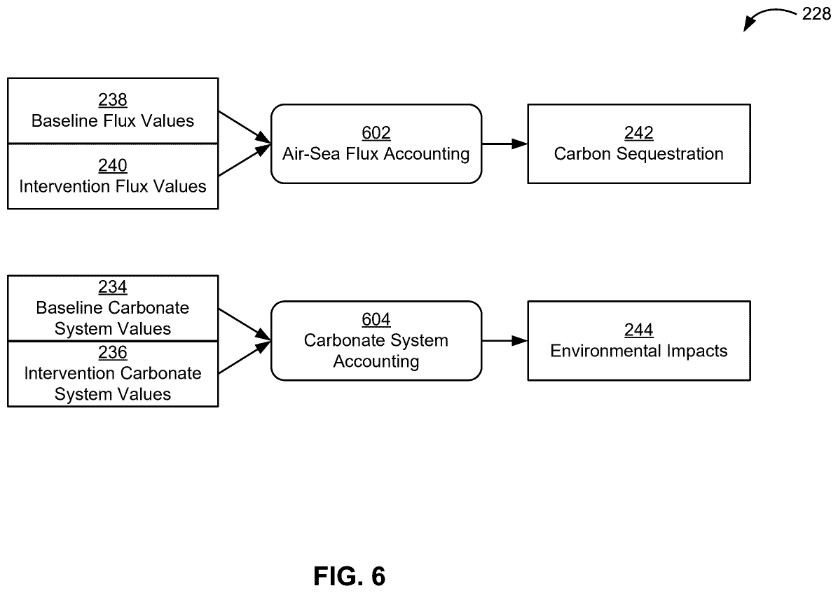

Evaluation apparatus 124 uses baseline carbonate system values 234 and intervention carbonate system values 236 outputted by carbonate system calculations 224 and baseline flux values 238 and intervention flux values 240 outputted by air-sea flux calculations 226 to generate results 228 associated with the effects of the mCDR intervention(s). In some embodiments, results 228 include a carbon sequestration 242 that is determined using baseline flux values 238 and/or intervention flux values 240. Results 228 can also, or instead, include a set of environmental impacts 244 that are determined using baseline carbonate system values 234 and/or intervention carbonate system values 236. Generation of results 228 associated with effects of mCDR interventions is described in further detail below with respect to FIG. 6.

FIG. 3 illustrates the use of plume dispersal simulation 222 to compute intervention concentrations 232 associated with one or more mCDR interventions, in accordance with the disclosed embodiments. As shown in FIG. 3, an intervention discretization 302 is used to convert intervention data 204 into particle data 312 representing a set of particles that are released by the mCDR intervention(s). For example, intervention discretization 302 may involve the use of rules, heuristics, formulas, and/or machine learning models to convert a site location, a type of a given mCDR intervention, quantities associated with the mCDR intervention, and/or other attributes that define or describe the mCDR intervention into a set of particles. Each particle may be represented by particle data 312 that includes (but is not limited to) a release time, release location, and/or mass of intervention (e.g., change in total alkalinity, dissolved inorganic carbon, pH, etc.). Intervention discretization 302 may be performed separately for each mCDR intervention to be modeled, so that different mCDR interventions are represented by different sets of particles.

Particle data 312 and ocean conditions 206 are inputted into a particle tracking model 304 to generate particle trajectories 314 for the particles. In some embodiments, particle tracking model 304 includes a Lagrangian particle tracking model that iteratively computes particle trajectories over a time period associated with the mCDR intervention(s) (e.g., a number of years over which the effects of the mCDR intervention(s) are to be estimated). For example, the Lagrangian particle tracking model may compute a new location of each particle at a given timestep within the time period based on the location of the particle at the previous timestep and variables such as currents and/or wind velocities associated with the location of the particle at the previous timestep. The Lagrangian particle tracking model may continue computing new locations of the particles over subsequent timesteps until each particle has an associated trajectory that specifies locations of the particle for all timesteps within the time period.

In some embodiments, the Lagrangian particle tracking model accounts for uncertainties associated with particle data 312, ocean conditions 206, and/or other input variables. For example, the Lagrangian particle tracking model may add noise to the input variables based on the magnitude of the corresponding uncertainties. In another example, the Lagrangian particle tracking model may use a variable scale that increases with the uncertainties.

Particle tracking model 304 may also, or instead, be implemented using other techniques. For example, particle tracking model 304 may include a graph neural network and/or another type of machine learning model that is trained using historical particle trajectories, particle data 312, and/or ocean conditions 206. After training is complete, the machine learning model may be used to generate predictions of new particle trajectories 314 based on the corresponding particle data 312 and ocean conditions 206.

A set of concentration calculations 306 is used to convert particle trajectories 314 into intervention concentrations 232 associated with the mCDR intervention(s). For example, the ocean volume may be divided into a three-dimensional (3D) spatial grid of cells, with each cell representing a discrete volume of water at a specific location and depth. At a given timestep, particle trajectories 314 (e.g., the latitude, longitude, and depth of a given particle at that timestep) are used to determine the number of particles in each grid cell. The total mass of intervention in each grid cell may be calculated by summing the masses of interventions of all particles located in the grid cell. The mass of intervention associated with each particle in the grid cell may be divided by this total mass of intervention to determine a “contribution” of the particle to the total mass of intervention for that timestep. Concentration calculations 306 may be performed for each timestep in plume dispersal simulation 222 to track changes to intervention concentrations 232 over time.

In one or more embodiments, intervention concentrations 232 include indications of whether or the corresponding particles are in contact with the surface. For example, intervention concentrations 232 may include a binary value defined for each point and/or cell in the grid. This binary value may be set to true if the depth associated with the point and/or cell is within the mixed layer (e.g., based on the mixed layer depth in ocean conditions 206) and to false otherwise.

FIG. 4 illustrates a set of carbonate system calculations 224 in accordance with the disclosed embodiments. As mentioned above, carbonate system calculations 224 may be performed in an alternating fashion with air-sea flux calculations 226 over a series of timesteps that span the time domain over which the effects of one or more mCDR interventions are to be evaluated. Thus, the output of calculations associated with a given timestep may be used as the input into calculations associated with the next timestep.

As shown in FIG. 4, a set of baseline carbonate system calculations 402 is used to generate a set of current timestep baseline carbonate system values 412 from carbonate system data 208. In one or more embodiments, current timestep baseline carbonate system values 412 represent the state of the carbonate system in the absence of the mCDR intervention(s) at a current timestep.

For example, input into baseline carbonate system calculations 402 may include at least two parameters from carbonate system data 208 (e.g., pCO₂, pH, total alkalinity, etc.) and additional attributes such as (but not limited to) surface temperature, surface pressure, wind velocity, salinity, and/or nutrient contents for the current timestep. Given this input, baseline carbonate system calculations 402 are used to compute remaining current timestep baseline carbonate system values 412. These current timestep baseline carbonate system values 412 may include (but are not limited to) a pH, surface concentration of dissolved inorganic carbon, surface concentration of pCO₂, and/or surface concentration of total alkalinity.

Next, a set of intervention carbonate system calculations 404 is used to generate a set of current timestep intervention carbonate system values 414 from current timestep baseline carbonate system values 412, intervention concentrations 232, a set of previous baseline flux values 416, and a set of previous intervention flux values 418. In one or more embodiments, current timestep intervention carbonate system values 414 represent the state of the carbonate system in the presence of the mCDR intervention(s) at the current timestep.

For example, input into intervention carbonate system calculations 404 may include an intervention total alkalinity associated with the intervention at the current timestep, which is computed as the sum of the total alkalinity from carbonate system data 208 and/or baseline carbonate system values for the current timestep and the total alkalinity associated with intervention concentrations 232 at the current timestep. Input into intervention carbonate system calculations 404 may also, or instead, include an intervention dissolved inorganic carbon, which is computed as the sum of the dissolved inorganic carbon from carbonate system data 208 and/or baseline carbonate system values for the current timestep and the additional flux associated with the intervention up to the previous timestep. This additional flux may be computed as the difference between previous baseline flux values 416 that are produced by air-sea flux calculations 226 and associated with an absence of the mCDR intervention(s) up to the previous timestep and previous intervention flux values 418 that are produced by air-sea flux calculations 226 associated with a presence of the mCDR intervention(s) up to the previous timestep. Given this input, intervention carbonate system calculations 404 are used to compute remaining current timestep intervention carbonate system values 414. These current timestep intervention carbonate system values 414 may include (but are not limited to) a pH, surface concentration of dissolved inorganic carbon, surface concentration of pCO₂, and/or surface concentration of total alkalinity. When previous baseline flux values 416 and previous intervention flux values 418 are available for one or more timesteps preceding the current timestep, current timestep intervention carbonate system values 414 may additionally include a cumulative dissolved inorganic carbon from the additional flux associated with the intervention and a concentration of the dissolved inorganic carbon associated with the additional flux at the surface.

Current timestep baseline carbonate system values 412 and current timestep intervention carbonate system values 414 can then be used to compute a set of current timestep carbonate system value changes 420 that represent the change in the state of the carbonate system caused by the mCDR intervention(s). For example, current timestep carbonate system value changes 420 may be computed by subtracting current timestep baseline carbonate system values 412 from current timestep intervention carbonate system values 414. Current timestep baseline carbonate system values 412 and current timestep intervention carbonate system values 414 may additionally be used in air-sea flux calculations 226 to produce baseline flux values 238 and intervention flux values 240 for the current timestep, as described in further detail below with respect to FIG. 5.

FIG. 5 illustrates a set of air-sea flux calculations 226 in accordance with the disclosed embodiments. As shown in FIG. 5, air-sea flux calculations 226 include a set of baseline flux calculations 502 that are used to compute a set of current timestep baseline flux values 512 from air-sea flux data 210 and current timestep baseline carbonate system values 412. In some embodiments, current timestep baseline flux values 512 represent air-sea CO₂ fluxes in the absence of the mCDR intervention(s) at a current timestep.

For example, input into baseline flux calculations 502 may include surface wind velocity, surface temperature, surface salinity, and/or sea ice concentration from air-sea flux data 210 and surface atmospheric pCO₂ from current timestep baseline carbonate system values 412. This input may be combined with the following equation to produce current timestep baseline flux values 512:

$$F = 0 \text{.251} 〈 {U}^{2} 〉 〉 {( Sc / 660 )}^{- 0.5} {K}_{0} ( {p CO}_{2 w} - {p CO}_{2 a} ) \qquad ( 1 )$$

In the above equation, F represents current timestep baseline flux values 512, [symbol] U² [symbol] denotes the average neutral stability winds at 10-m height squared, Sc represents the Schmidt number, K₀ denotes solubility of CO₂, and pCO_{2w} and pCO₂ₐ represent pCO₂ values in equilibrium with surface water and in the air above the surface, respectively.

Air-sea flux calculations 226 additionally include a set of intervention flux calculations 504 that are used to compute a set of current timestep intervention flux values 514 from air-sea flux data 210 and current timestep intervention carbonate system values 414. In some embodiments, current timestep intervention flux values 514 represent air-sea CO₂ fluxes in the presence of the mCDR intervention(s) at the current timestep.

For example, input into intervention flux calculations 504 may include surface wind velocity, surface temperature, surface salinity, and/or sea ice fraction from air-sea flux data 210 and surface atmospheric pCO₂ from current timestep intervention carbonate system values 414. This input may be combined with Equation 1 to produce current timestep intervention flux values 514.

Current timestep baseline flux values 512 and current timestep intervention flux values 514 can then be used to compute a set of current timestep flux value changes 520 that represent the change in air-sea flux caused by the mCDR intervention(s). For example, current timestep flux value changes 520 may be computed by subtracting current timestep baseline flux values 512 from current timestep intervention flux values 514. Current timestep baseline flux values 512, current timestep intervention flux values 514, and/or current timestep flux value changes 520 may additionally be used in carbonate system calculations 224 to produce baseline carbonate system values 234 and intervention carbonate system values 236 for the next timestep, as described above with respect to FIG. 4.

FIG. 6 illustrates the generation of a set of results 228 associated with stochastic modeling of one or more mCDR interventions, in accordance with the disclosed embodiments. As shown in FIG. 6, results 228 include carbon sequestration 242, which is generated via an air-sea flux accounting 602 from baseline flux values 238 and intervention flux values 240. For example, air-sea flux accounting 602 may compute carbon sequestration 242 by summing intervention flux values 240 for the particles across a temporal domain (e.g., one or more time periods) and/or spatial domain (e.g., one or more geographic regions and/or depths) and comparing the summed intervention flux values 240 with the corresponding summed baseline flux values 238.

Results 228 also include a set of environmental impacts 244 that are generated via a carbonate system accounting 604 from baseline carbonate system values 234 and intervention carbonate system values 236. For example, carbonate system accounting 604 may average differences in pH and/or other attributes between baseline carbonate system values 234 and intervention carbonate system values 236 across temporal and/or spatial domains to determine the extent to which the mCDR intervention(s) mitigate ocean acidification. Baseline carbonate system values 234 and intervention carbonate system values 236 may also, or instead, be compared with tolerance distributions of various marine organisms for the corresponding attributes to determine the effects of the mCDR intervention(s) on habitats for the marine organisms.

In one or more embodiments, evaluation apparatus 124 and/or another component include functionality to output results 228 and/or other values generated by plume dispersal simulation 222, carbonate system calculations 224, air-sea flux calculations 226 in one or more tables, charts, graphs, and/or other types of visualizations. For example, the component may generate a map visualization that shows the spatial distribution of intervention concentrations 232 and/or particle trajectories 314 over time. This map visualization may use color gradients to represent intervention concentrations, carbonate system values, air-sea fluxes, and/or flux completions associated with individual particles, thereby allowing users to visually track the dispersal of the mCDR intervention(s) across the ocean and/or the effects of the mCDR intervention(s) at various locations in the ocean.

In another example, the component may produce one or more time series charts of carbonate system values and/or air-sea fluxes over the time period for which the effects of the mCDR intervention(s) are modeled. These time series chart(s) may include separate lines for different baseline carbonate system values 234, intervention carbonate system values 236, baseline flux values 238, intervention flux values 240, and/or particles to facilitate comparison of pH levels, dissolved inorganic carbon concentrations, partial pressures of carbon dioxide, total alkalinities, fluxes, and/or other attributes in the presence and absence of the mCDR intervention(s).

In a third example, the component may generate a heat map visualization to represent flux completion as a function of depth and distance from the source of a given mCDR intervention. This heat map may include one axis that represents depth and another axis that represents distance from the source. The heat map may additionally use color intensity to indicate the amount of unrealized flux potential at a given combination of depth and distance from the source.

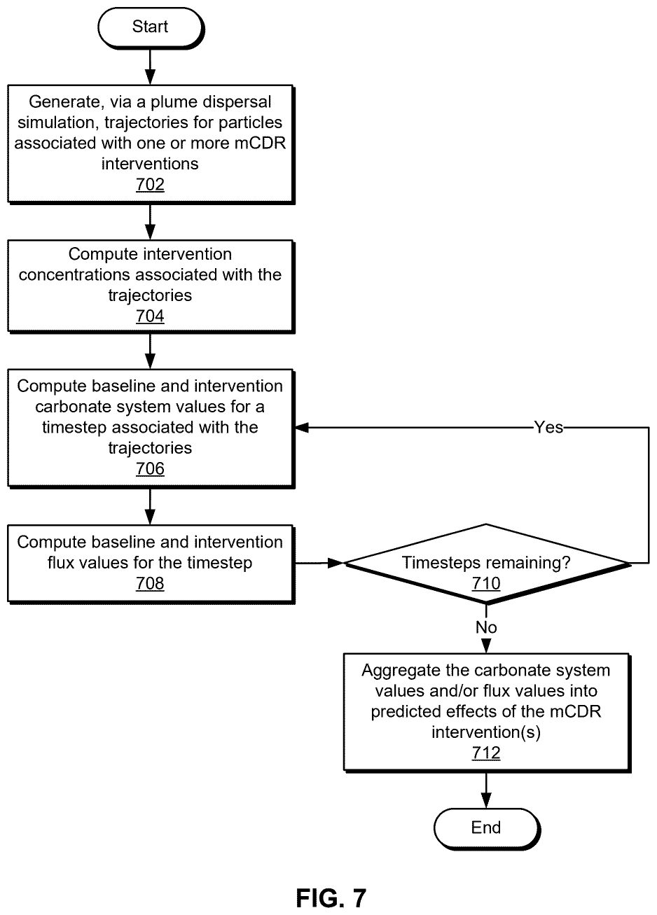

FIG. 7 illustrates a flowchart of method steps for modeling an mCDR system in accordance with the disclosed embodiments. In one or more embodiments, one or more of the steps may be omitted, repeated, and/or performed in a different order. Accordingly, the specific arrangement of steps shown in FIG. 7 should not be construed as limiting the scope of the embodiments.

Initially, trajectories for particles associated with one or more mCDR interventions are generated via a plume dispersal simulation (operation 702). The plume dispersal simulation may use a Lagrangian particle tracking technique to simulate the dispersal of particles associated with the mCDR interventions over a specified time period and geographic region. Release times, release locations, masses of intervention, and/or other attributes of the particles may be determined using plume source definitions associated with the mCDR intervention(s). The Lagrangian particle tracking technique may then be used to compute the trajectories as locations of the particles at different timesteps within the time period, given input that includes the attributes of the particles and ocean conditions such as (but not limited to) mixed layer depth, salinity, temperature, surface wind, surface current, bottom current, and/or intermediate depth currents.

Next, intervention concentrations associated with the trajectories are computed (operation 704). For example, locations of the particles at individual timesteps may be associated with different cells within a 3D grid, where each cell represents a discrete volume of water at a specific location and depth. A total mass of intervention in each grid cell may be calculated by summing the masses of interventions of all particles located in the grid cell. The mass of intervention for each particle may be divided by this total mass of intervention to determine the proportional contribution of the particle to the total mass of intervention. The intervention surface concentration may also be determined by scaling particle masses by their depths and/or by another value that is computed as a function of the particle properties.

Baseline and intervention carbonate system values are also computed for a timestep associated with the trajectories (operation 706). For example, two or more baseline carbonate system values may be used to solve for remaining baseline carbonate system values. Two or more baseline carbonate system values may then be combined with additional values associated with the intervention concentrations and/or additional flux associated with the intervention up to the previous timestep to produce two or more corresponding intervention carbonate system values. These intervention carbonate system values may then be used to solve for the remaining intervention carbonate system values.

Baseline and intervention flux values are additionally computed for the timestep (operation 708). For example, the baseline and intervention carbonate system values determined in operation 706 may be combined with air-sea flux data to calculate the baseline and intervention flux values, respectively.

After the baseline and intervention carbonate system values and flux values have been computed for a given timestep, a determination is made as to whether or not timesteps remain (operation 710). For example, a determination may be made that timesteps remain if the timestep associated with the most recently computed baseline and intervention carbonate system values and flux values does not correspond to the end of the time period over which the mCDR system is to be modeled. If additional timesteps remain, operations 706 and 708 are repeated to compute baseline and intervention carbonate system values and flux values for the next timestep. Operation 710 is also repeated to determine whether or not to continue computing baseline and intervention carbonate system values and flux values for subsequent timesteps.

Once the determination is made that no timesteps remain (e.g., when the timestep associated with the most recently computed baseline and intervention carbonate system and flux values corresponds to the end of the time period), the carbonate system values and/or flux values are aggregated into predicted effects of the mCDR intervention(s) (operation 712). For example, the baseline and intervention flux values may be summed across a temporal domain and/or spatial domain, and the results may be compared to estimate carbon sequestration associated with the mCDR intervention(s). In another example, the average change in pH over the time period and/or a geographic region may be used to determine a mitigation in ocean acidification associated with the mCDR intervention(s).

### Entropy Respecting Approximation of Lagrangian Particle Tracking

While the Lagrangian particle tracking technique described above can be used to model particle dispersion and estimate effects associated with mCDR interventions in a time- and resource-efficient manner, an inconsistency in the Lagrangian particle tracking technique can result in a solute distribution that is physically unrealistic. More specifically, the Lagrangian particle tracking technique tracks zero-dimensional particles through the ocean. However, zero-dimensional particles can exhibit clustering and stranding, which causes the particles to behave like a suspension instead of a substance that is dissolved in water (or another fluid).

Furthermore, this clustering and stranding is likely to occur near the surface, which can inflate the intervention surface concentrations from which mCDR sequestration flux rates are calculated. For example, particle distributions generated via Lagrangian particle tracking may include trapping of a significant number of particles (e.g., more than 30%) in shallow bays, producing intervention hotspots away from the source. These trapped particles may exaggerate the efficacy of the mCDR intervention, as the depth of the intervention plume is a key driver of carbon dioxide flux.

To address the above limitations, the disclosed embodiments use an “entropy respecting approximation” of Lagrangian particle tracking to prevent the unrealistic buildup of particles in embayments and/or other types of traps near shorelines. As described in further detail below, this entropy respecting approximation may use an entropy constraint to selectively relocate particles, thus preventing particle trajectories from concentrating over time. Consequently, the disclosed embodiments may improve the accuracy and applicability of mCDR intervention models and/or other technologies that use Lagrangian particle tracking to simulate the dispersal of dissolved substances.

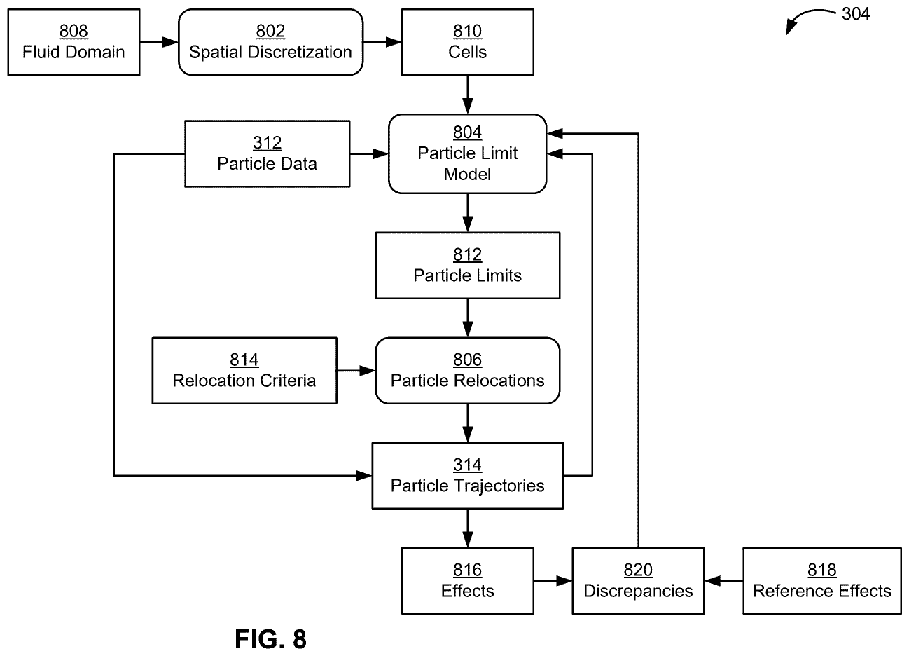

FIG. 8 illustrates particle tracking model 304 that corrects for inconsistencies in the distribution of particles generated via a Lagrangian particle tracking technique, in accordance with the disclosed embodiments. As shown in FIG. 8, a spatial discretization 802 is applied to a fluid domain 808 that corresponds to a spatial region occupied by a fluid. For example, fluid domain 808 may include an ocean, lake, river, aquifer, and/or another body of water (or another type of fluid) into which a plume is released and/or dispersed. This spatial discretization 802 may be used to divide fluid domain 808 into multiple discrete cells 810, such as (but not limited to) fixed-size grid cells and/or variable-size and/or variable-shape mesh cells.

A particle limit model 804 is used to generate particle limits 812 associated with individual cells 810 based on particle data 312 for particles in each cell. In some embodiments, each particle limit represents an upper bound on the number of particles in a corresponding cell. For an ocean-based fluid domain 808, a different particle limit may be computed for each combination of cell and depth range.

In some embodiments, particle data 312 includes attributes of particles that can be used to characterize entropy within cells 810. For example, particle data 312 may include (but is not limited to) a location of each particle over one or more time steps, the age of each particle, a history of neighbor counts associated with each particle (e.g., as determined using a count of particles that is within a certain distance of the particle for a number of previous timesteps), and/or a turbulence experienced by the particle over time (e.g., a sum and/or history of mix layer depths through which the particle has transitioned over a number of previous time steps).

Particle data 312 may also, or instead, include data associated with cells 810 across which the plume is dispersed. For example, particle data 312 may include a distance between each cell and an origin of the plume.

In one or more embodiments, particle limit model 804 includes a machine learning model, one or more mathematical functions, one or more rules and/or heuristics, and/or another representation. Particle limit model 804 may include a set of parameters (e.g., neural network weights, coefficients, etc.) that are combined with particle data 312 and/or values derived from particle data 312 to produce particle limits 812.

For example, a particle limit for a given cell may be computed based on an inverse square of the distance between the cell and the origin of the plume, so that cells that are farther from the origin have lower particle limits than cells that are closer to the origin. The particle limit may also, or instead, be computed based on an inverse of an aggregate (e.g., summed, average, etc.) age of particles in the cell, so that cells with older particles have lower particle limits than cells with younger particles. The particle limit may also, or instead, be computed based on a previous neighbor count and/or an aggregate of multiple previous neighbor counts for each particle to ensure that the number of neighbors associated with each particle decreases over time at a certain rate. The particle limit may also, or instead, be computed based on an aggregate turbulence experienced by particles in the cell, so that cells with particles that have experienced less turbulence have lower particle limits than cells with particles that have experienced greater turbulence.

A set of particle relocations 806 is performed based on particle limits 812 and a set of relocation criteria 814. More specifically, during a given timestep of the dispersal simulation, a count of particles in each cell 810 is compared with a corresponding particle limit from particle limit model 804. If the count of particles exceeds the particle limit, a subset of particles in the cell is relocated to one or more other cells, such as (but not limited to) one or more adjacent cells within fluid domain 808. The subset of particles to be relocated may be selected randomly and/or based on attributes of the particles in particle data 312, such as (but not limited to) the age of the particles, the turbulence experienced by the particles, distances between the locations of the particles and boundaries of the corresponding cells 810 and/or fluid domain 808, and/or the neighbor counts associated with the particles.

In some embodiments, relocation criteria 814 may specify constraints, requirements, and/or rules that affect particle relocations 806. For example, relocation criteria 814 may specify that a particle is to be moved by a distance that is sampled from a distribution, such as a Gaussian distribution that is parameterized based on one or more dimensions of the cell. Relocation criteria 814 may also, or instead, specify a minimum and/or maximum distance by which a particle can be moved.

Relocation criteria 814 may also, or instead, specify that a particle is to be relocated to a location that does not lie outside fluid domain 808. Thus, if a given particle is randomly (or otherwise) moved to a location that lies outside fluid domain 808 (e.g., a location on land for a water-based fluid domain 808), the location may be resampled (or otherwise determined) until the location falls within fluid domain 808.

Relocation criteria 814 may also, or instead, specify that a relocated particle is to be moved to a location that is not included in a trajectory of the particle over a number of previous timesteps. This can prevent the particle from “bouncing” between previously occupied locations.

After particle relocations 806 are performed, particle trajectories 314 are updated to reflect the new locations of the relocated particles. The updated particle trajectories 314 may then be used to compute a set of effects 816 associated with the plume, such as (but not limited to) intervention concentrations 232, carbonate system values (e.g., baseline carbonate system values 234, intervention carbonate system values 236), flux values (e.g., baseline flux values 238, intervention flux values 240), carbon sequestration 242, and/or environmental impacts 244, as discussed above.

In one or more embodiments, effects 816 are compared with a set of reference effects 818 to determine discrepancies 820 that are used to update parameters of particle limit model 804, relocation criteria 814, and/or other factors that affect particle relocations 806, particle trajectories 314, and/or effects 816. More specifically, discrepancies 820 may be computed as differences between effects 816 and reference effects 818 from another model (e.g., a different model of mCDR and/or other effects associated with the plume). These differences may be used with a training and/or optimization technique (e.g., least squares, gradient descent and backpropagation, a search technique, etc.) to update parameters of particle tracking model 304, relocation criteria 814, and/or the other factors. A new set of particle limits 812, particle relocations 806, particle trajectories 314, effects 816, and/or discrepancies 820 may be determined using the updated parameters, and the process may be repeated until discrepancies 820 fall below a threshold, the parameters have been updated over a certain number of iterations, the parameters have been updated based on a certain number of datasets and/or data points that include reference effects 818, and/or another condition is met.

The optimized particle limit model 804, relocation criteria 814, and/or other factors may then be used to compute additional effects 816 of other plumes in fluid domain 808 and/or other fluid domains. For example, the optimized factors may be used to predict carbon sequestration 242, environmental impacts 244, and/or other effects associated with a plume of an mCDR intervention and/or another substance that is released and/or dissolved into an ocean, lake, and/or another body of water.

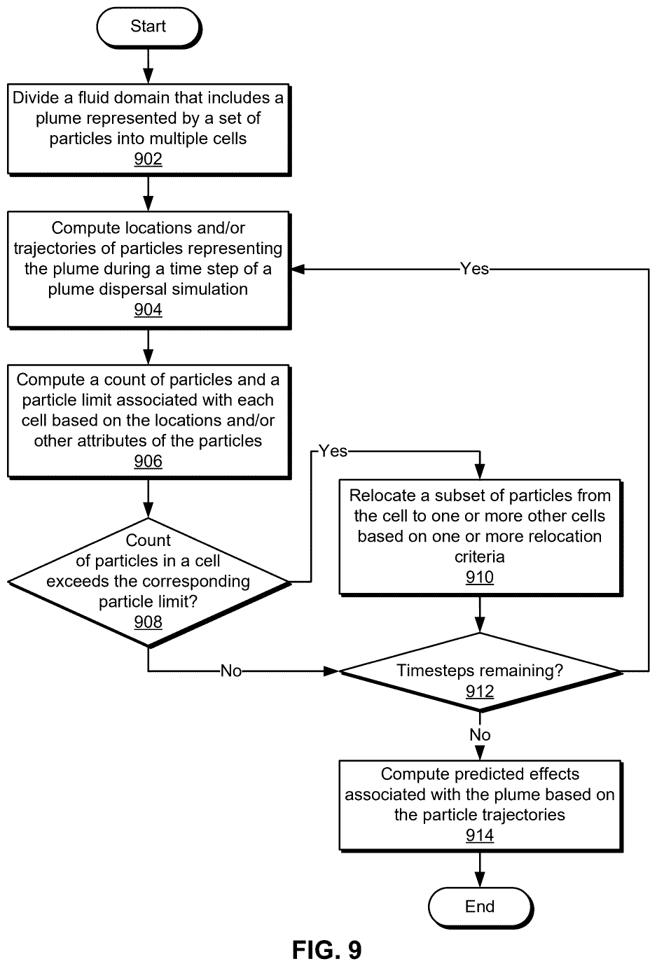

FIG. 9 illustrates a flowchart of method steps for modeling particle movement within a fluid domain, in accordance with the disclosed embodiments. In one or more embodiments, one or more of the steps may be omitted, repeated, and/or performed in a different order. Accordingly, the specific arrangement of steps shown in FIG. 9 should not be construed as limiting the scope of the embodiments.

Initially, a fluid domain that includes a plume is divided into multiple cells (operation 902). For example, an ocean, lake, and/or another body of water corresponding to the fluid domain may be divided into contiguous fixed-size grid cells, irregular mesh cells, and/or other discrete representations of area and/or volume.

Next, locations and/or trajectories of particles representing the plume are computed during a time step of a plume dispersal simulation (operation 904). For example, a Lagrangian particle tracking technique may be used to compute the particle locations and/or trajectories based on previous locations of the particles and conditions such as (but not limited to) surface wind velocity, surface current velocity, bottom current velocity, intermediate current velocities at depth, and/or mixed layer depth.

A count of particles and a particle limit associated with each cell are computed based on the locations and/or other attributes of the particles (operation 906). For example, the particle limit for a given cell may be determined using a particle limit model that computes the particle limit based on a set of weights, coefficients, and/or other parameters and attributes such as (but not limited to) a distance between the cell and an origin of the plume, an aggregate age of particles in the cell, an aggregate number of neighbors associated with particles in the cell, and/or an aggregate turbulence experienced by particles in the cell. The count of particles may be determined as the number of particles that are located in the cell.

A determination is made as to whether the count of particles in a cell exceeds the corresponding particle limit (operation 908). For example, the count of particles in each cell may be compared to a corresponding numeric particle limit representing an upper bound on the number of particles in the cell. If the count of particles in a cell does not exceed the corresponding particle limit, no changes are made to the locations and/or trajectories of the particles in the cell.

If the number of particles in a given cell exceeds the corresponding particle limit, a subset of particles from the cell is relocated to one or more other cells based on one or more relocation criteria (operation 910). For example, a subset of particles in excess of the particle limit may be relocated to outside the cell based on the relocation criteria. The relocation criteria may specify that a particle is to be moved by a distance that is sampled from a distribution, the particle is to be relocated to a location that does not lie outside the fluid domain, and/or the particle is to be moved to a location that is not included in a trajectory of the particle over a number of previous timesteps. If a new location to which a particle is to be moved does not satisfy one or more relocation criteria, the new location may be resampled (or otherwise determined) until the new location is verified to meet all relocation criteria.

After the particle relocations have been performed for a given timestep, a determination is made as to whether or not timesteps remain (operation 912). For example, a determination may be made that timesteps remain if the timestep associated with the most recently computed particle locations does not correspond to the end of the time period over which the plume dispersal is to be simulated. If additional timesteps remain, operations 904, 906, 908, and 910 are repeated to compute particle locations, particle limits, and particle relocations for the next timestep. Operation 912 is also repeated to determine whether or not to continue the simulation for subsequent timesteps.

Once the determination is made that no timesteps remain (e.g., when the timestep associated with the most recently computed particle locations corresponds to the end of the time period), predicted effects associated with the plume are computed based on the particle trajectories (operation 914). For example, the particle trajectories may be used to compute particle concentrations for each grid cell. The particle concentrations may be used to compute carbonate system values, air-sea flux values, and/or other types of “intervention” values associated with the plume over the time period. The computed values may then be aggregated and/or otherwise used to estimate carbon sequestration, environmental impacts, and/or other effects associated with the plume. As mentioned above, the effects may also be compared with reference effects from a different model, and differences between the effects and reference effects may be used to update parameters of the particle tracking model, relocation criteria, and/or other factors that affect the computation and/or adjustment of particle trajectories by the plume dispersal simulation.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing code and/or data now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium.

Furthermore, methods and processes described herein can be included in hardware modules or apparatus. These modules or apparatus may include, but are not limited to, an application-specific integrated circuit (ASIC) chip, a field-programmable gate array (FPGA), a dedicated or shared processor (including a dedicated or shared processor core) that executes a particular software module or a piece of code at a particular time, and/or other programmable-logic devices now known or later developed. When the hardware modules or apparatus are activated, they perform the methods and processes included within them.

The foregoing descriptions of various embodiments have been presented only for purposes of illustration and description. They are not intended to be exhaustive or to limit the present invention to the forms disclosed. Accordingly, many modifications and variations will be apparent to practitioners skilled in the art. Additionally, the above disclosure is not intended to limit the present invention.

What is claimed is:

1. A method for modeling particle movement within a fluid domain, comprising:
dividing the fluid domain that includes a plume into a plurality of cells;
upon determining, during a current time step of a plume dispersal simulation associated with the plume, that a particle limit associated with a cell in the plurality of cells is exceeded by a count of a plurality of particles that (i) represent at least a subset of the plume and (ii) are located in the cell:
relocating a subset of the plurality of particles in the cell to one or more additional cells in the plurality of cells; and
determining a plurality of trajectories for the plurality of particles based on the relocated subset of the plurality of particles; and
causing a set of predicted effects associated with the plume to be generated based on the plurality of trajectories.

2. The method of claim 1, further comprising determining the particle limit associated with the cell based on (i) a set of attributes associated with the plurality of particles in the cell and (ii) a set of parameters associated with the set of attributes.

3. The method of claim 2, further comprising:
determining a discrepancy between the set of predicted effects and a set of reference effects associated with the plume; and
updating the set of parameters based on the discrepancy.

4. The method of claim 2, wherein the set of attributes comprises at least one of:
a distance between the cell and an origin of the plume;
an aggregate age associated with the plurality of particles;
an aggregate number of neighbors associated with the plurality of particles; or
an aggregate turbulence associated with the plurality of particles.

5. The method of claim 1, wherein relocating the subset of the plurality of particles in the cell comprises moving a particle in the subset of the plurality of particles based on a distance that is sampled from a distribution.

6. The method of claim 1, wherein relocating the subset of the plurality of particles comprises verifying that a particle in the subset of the plurality of particles has been moved to a location that meets one or more relocation criteria.

7. The method of claim 6, wherein verifying that the particle has been moved to the location that meets the one or more relocation criteria comprises at least one of:
verifying that the location does not lie outside the fluid domain; or
verifying that a trajectory of the particle over a number of previous timesteps does not include the location.

8. The method of claim 1, wherein causing the set of predicted effects to be generated comprises:
determining, based on the relocated subset of the plurality of particles, a plurality of particle concentrations associated with the plurality of cells;
computing a set of intervention values associated with the plurality of particle concentrations; and
generating the set of predicted effects based on the set of intervention values and a set of baseline values associated with an absence of the plume in the fluid domain.

9. The method of claim 8, wherein the set of intervention values comprises at least one of a flux value or a carbonate system value.

10. The method of claim 1, wherein the set of predicted effects comprises at least one of a carbon sequestration or an environmental impact.

11. The method of claim 1, wherein the plurality of cells comprises at least one of a fixed-size grid cell or a variable-size mesh cell.

12. The method of claim 1, wherein the one or more additional cells are adjacent to the cell.

13. One or more non-transitory computer-readable storage media storing instructions that, when executed by one or more processors, cause the one or more processors to perform operations comprising:
dividing a fluid domain that includes a plume represented by a plurality of particles into a plurality of cells;
upon determining, during a current time step of a plume dispersal simulation associated with the plume, that a particle limit associated with a cell in the plurality of cells is exceeded by a count of a plurality of particles that (i) represent at least a subset of the plume and (ii) are located in the cell:
relocating a subset of the plurality of particles in the cell to one or more additional cells in the plurality of cells; and
determining a plurality of trajectories for the plurality of particles based on the relocated subset of the plurality of particles; and
causing a set of predicted effects associated with the plume to be generated based on the plurality of trajectories.

14. The one or more non-transitory computer-readable storage media of claim 13, wherein the operations further comprise determining, via execution of a machine learning model, the particle limit associated with the cell based on a set of attributes associated with the plurality of particles.

15. The one or more non-transitory computer-readable storage media of claim 14, wherein the operations further comprise:
determining a discrepancy between the set of predicted effects and a set of reference effects associated with the plume; and
training the machine learning model based on the discrepancy.

16. The one or more non-transitory computer-readable storage media of claim 14, wherein the set of attributes comprises at least one of:
a distance between the cell and an origin of the plume;
an aggregate age associated with the plurality of particles;
an aggregate number of neighbors associated with the plurality of particles; or
an aggregate turbulence associated with the plurality of particles.

17. The one or more non-transitory computer-readable storage media of claim 13, wherein relocating the subset of the plurality of particles in the cell comprises moving a particle in the subset of the plurality of particles based on a distance that is sampled from a Gaussian distribution that is parameterized based on one or more dimensions of the cell.

18. The one or more non-transitory computer-readable storage media of claim 13, wherein relocating the subset of the plurality of particles in the cell comprises verifying that a particle in the subset of the plurality of particles has been moved to a location that (i) does not lie outside the fluid domain or (ii) is not included in a trajectory of the particle over a number of previous timesteps.

19. The one or more non-transitory computer-readable storage media of claim 13, wherein the plume is released during a marine carbon dioxide removal intervention into a body of water corresponding to the fluid domain.

20. A system, comprising:
one or more processors; and
memory storing instructions that, when executed by the one or more processors, cause the system to perform operations comprising:
dividing a fluid domain that includes a plume represented by a plurality of particles into a plurality of cells;
upon determining, during a current time step of a plume dispersal simulation associated with the plume, that a particle limit associated with a cell in the plurality of cells is exceeded by a count of a plurality of particles that (i) represent at least a subset of the plume and (ii) are located in the cell:
relocating a subset of the plurality of particles in the cell to one or more additional cells in the plurality of cells; and
determining a plurality of trajectories for the plurality of particles based on the relocated subset of the plurality of particles; and
causing a set of predicted effects associated with the plume to be generated based on the plurality of trajectories.
